(19) United States
(12) Patent Application Publication
(10) Pub. No.: US 2011/0152087 A1
(43) Pub. Date: Jun. 23, 2011

(54) Herbicidal compositions comprising flufenacet

(75) Inventors: Hubert Menne, Mainz-Kastel (DE); Susan Cross, Langenfeld (DE); Dominique Schreiber, Dusseldorf (DE); Victor Jose Marceles Palma, Dusseldorf (DE)

(73) Assignee: Bayer CropScience AG, Monheim (DE)

(21) Appl. No.: 12/971,385

(22) Filed: Dec. 17, 2010

(30) Foreign Application Priority Data
Dec. 17, 2009 (DE) 102009054849.1

(51) Int. Cl. A01N 25/32; A01N 43/40; A01P 7/04; A01P 3/00; A01P 13/00

(52) U.S. Cl. 504/103; 504/130

(57) ABSTRACT

Herbicidal compositions are disclosed, comprising an effective amount of flufenacet, diclofop(-P-methyl) and diflufenican. A method of controlling harmful plants is disclosed. The disclosed herbicidal compositions have an improved application profile with regard to an improved application flexibility of the active compounds extending into post-emergence of the crop and weed plants; and the herbicidal action on the weed plants and at the same time the crop compatibility are improved.

### FIELD OF THE INVENTION

The invention is in the technical field of crop protection compositions which can be used against harmful plants, for example in crop plants, and which comprise, as active compounds in the herbicidal compositions, a combination of flufenacet and a plurality of other herbicides.

### BACKGROUND OF THE INVENTION

The herbicidally active compound flufenacet (manufacturer: Bayer CropScience) is distinguished by broad activity against mono- and dicotyledonous harmful plants and is used, for example, by the pre-sowing method, the pre-emergence method or the post-emergence method in sown or planted agricultural or horticultural crop plants and also on non-crop land (for example in cereals such as wheat, barley, rye, oats, triticale, rice, corn, millet, sugar beet, sugar cane, oilseed rape, cotton, sunflowers, soybeans, potatoes, tomatoes, beans, flax, pasture grass, fruit plantations, plantation crops, greens/lawns and also squares of residential areas or industrial sites, rail tracks).

As individual active compound, flufenacet is commercially available, for example, under the trade names Cadou®, Drago®, Define® and Tiara®. In addition to the use of the individual active compound, mixtures of flufenacet with other herbicides are also disclosed in the literature (for example U.S. Pat. No. 5,985,797 B, U.S. Pat. No. 5,593,942 B, U.S. Pat. No. 5,912,206 B, U.S. Pat. No. 5,811,373 B, U.S. Pat. No. 5,858,920 B; U.S. Pat. No. 6,967,188 B, U.S. Pat. No. 6,492,301 B, U.S. Pat. No. 6,864,217 B, U.S. Pat. No. 6,486,096 B; US 2003/0069138 A, WO 2002/058472 A, U.S. Pat. No. 6,365,550 B, US 2003/0060367 A, U.S. Pat. No. 6,878,675 B, U.S. Pat. No. 6,071,858 B, WO 2007/112834 A) and commercially available: mixtures with metribuzin (for example Axiom®, Bastille®, Artist®, Domain®, Plateen®, Fedor®, Draeda®), with isoxaflutole (for example Epic®, Cadou Star®), with metosulam (for example Diplôme®, Terano®), with diflufenican (for example Herold®, Liberator®), with 2,4-D (for example Drago 3.4®), with atrazine (for example Aspect®), with pendimethalin (for example Crystal®, Malibu Pack®), with atrazine and metribuzin (for example Axiom AT®) and with diflufenican and flurtamone (for example Baccara FORTE®).

Although flufenacet, as individual active compound and in the mixtures already known, has good activity, there is still a need for improving the application profile of this active compound in specific areas of use. There are various reasons for this, such as, for example, further increase of efficacy in specific areas of use, enhancement of crop plant compatibility, reaction to novel production techniques in individual crops and/or the increasing occurrence of herbicide-resistant harmful plants (for example TSR and EMR resistances in ALS and ACCase), for example in cereals, rice and corn. These improvements of the application profile can be of importance both individually and also in combination with one another.

One way of improving the application profile of a herbicide may be to combine the active compound with one or more other suitable active compounds. However, in the combined application of a plurality of active compounds, there are frequently phenomena of physical and biological incompatibility, for example lack of stability of a coformulation, decomposition of an active compound and/or antagonism of the active compounds. What is desired, however, are combinations of active compounds having a favorable activity profile, high stability and ideally a synergistically enhanced activity which allows the application rate to be reduced compared to the individual application of the active compounds to be combined. Likewise desirable are combinations of active compounds which increase crop plant compatibility in general and/or can be used for specific production techniques. These include, for example, a reduction of sowing depth which, for crop compatibility reasons, can frequently not be used. In this manner, in general a more rapid emergence of the crop is achieved, their risk of emergence diseases (such as, for example, Pythium and Rhizoctonia) is reduced, and winter survival and stocking are improved. This also applies to late sowing which would otherwise not be possible owing to the crop compatibility risk.

It was an object of the present invention to improve the application profile of the herbicidally active compound flufenacet with respect to an improved application flexibility of the active compounds from pre-emergence to post-emergence of the crop and the weed plants.

This object was achieved in whole or in part by providing herbicidal compositions comprising flufenacet and the other herbicides diclofop(-P-methyl) and diflufenican.

### SUMMARY OF THE INVENTION

The invention therefore provides herbicidal compositions comprising, as the only herbicidally active components:
A) flufenacet (component A),
B) diclofop(-P-methyl) (component B) and
C) diflufenican (component C).

### DETAILED DESCRIPTION OF THE INVENTION

The active compounds referred to in the present description by their “common name” (herbicidally active components) are known, for example, from “The Pesticide Manual”, 14^{th} edition 2006/2007, or from the corresponding “The e-Pesticide Manual”, version 4.0 (2006-07), both published by the British Crop Protection Council and the Royal Soc. of Chemistry, and from “The Compendium of Pesticide Common Names” on the internet (website: http://www.alanwood.net/pesticides/).

Hereinbelow, the herbicidally active components A, B and C are together referred to as “(individual) active compounds”, “(individual) herbicides” or as “herbicide components” and are known, as individual compounds or as mixtures, for example from “The Pesticide Manual”, 14^{th} edition (see above), where they have the following entry number (abbreviation: “PM # . . . ” with the respective sequential entry number):
component A: flufenacet (PM #381), syn. thiafluamide, for example N-(4-fluorophenyl)-N-(1-methylethyl)-2-[[5-(trifluoromethyl)-1,3,4-thiadiazol-2-yl]oxy]acetamide;
component B: diclofop (PM #243), for example (±)-2-[4-(2,4-dichlorophenoxy)phenoxy]propanoic acid, also comprising esters thereof, in particular diclofop-methyl (for example, methyl 2-[4-(2,4-dichlorophenoxy)phenoxy]propanoate), as racemate or isomers, in particular diclofop-P-methyl (PM #244), for example methyl (+)-2-[4-(2,4-dichlorophenoxy)phenoxy]propanoate;
component C: diflufenican (PM #258), for example N-(2,4-difluorophenyl)-2-[3-(trifluoromethyl)phenoxy]-3-pyridinecarboxamide.

If, in the context of this description, the short form of the “common name” of an active compound is used, this embraces—if applicable—in each case all customary derivatives, such as esters and salts, and isomers, in particular optical isomers, especially the commercially available form or forms. If the “common name” refers to an ester or a salt, this embraces in each case also all other customary derivatives, such as other esters and salts, the free acids and neutral compounds, and isomers, in particular optical isomers, especially in the commercially available form or forms. The given chemical compound names refer to at least one of the compounds embraced by the “common name”, frequently to a preferred compound.

If the abbreviation “AS/ha” is used in the present description, it means “active substance per hectare”, based on 100% active compound. All percentages in the description are percent by weight (abbreviated “% by weight”) and, unless defined otherwise, refer to the relative weight of the respective component based on the total weight of the herbicidal composition (for example as formulation).

The invention also provides herbicidal compositions consisting essentially of, as the only herbicidally active components, A) flufenacet (component A), B) diclofop(-P-methyl) (component B) and C) diflufenican (component C).

The invention also provides herbicidal compositions consisting of, as the only herbicidally active components, A) flufenacet (component A), B) diclofop(-P-methyl) (component B) and C) diflufenican (component C).

The invention also provides herbicidal compositions comprising a herbicidally active component wherein the herbicidally active component consists essentially of A) flufenacet (component A), B) diclofop(-P-methyl) (component B) and C) diflufenican (component C).

The invention also provides herbicidal compositions comprising a herbicidally active component wherein the herbicidally active component consists of A) flufenacet (component A), B) diclofop(-P-methyl) (component B) and C) diflufenican (component C).

The herbicidal compositions according to the invention comprise a herbicidally effective amount of components A, B and C and may comprise further components, for example agrochemically active compounds from the group of the insecticides, fungicides and safeners, and/or formulation auxiliaries and/or additives customary in crop protection, or be used together with these. The formulation auxiliaries and/or additives are generally agriculturally acceptable. The term “agriculturally acceptable” includes those formulation auxiliaries and/or additives that are customary in crop protection.

In a preferred embodiment, the herbicidal compositions according to the invention have, as an improvement of the application profile, synergistic effects. These synergistic effects can be observed, for example, when the herbicide components are applied together, but they can frequently also be observed when the compounds are applied as a split application over time. Another possibility is the application of the individual herbicides or the herbicide combinations in a plurality of portions (sequential application), for example after pre-emergence applications, followed by post-emergence applications or after early post-emergence applications, followed by applications at medium or late post-emergence. Preferred is the simultaneous or nearly simultaneous application of the active compounds of the herbicidal compositions according to the invention.

The synergistic effects allow the application rates of the individual active compounds to be reduced, a more potent action at the same application rate, the control of hitherto uncontrollable species (gaps), an extended application period and/or a reduced number of individual applications required and—as a result for the user—more advantageous weed control systems both from an economical and ecological point of view.

The application rate of the herbicide components and their derivatives in herbicidal composition may vary within wide ranges. In applications with application rates of from 61 to 5500 g of AS/ha of the herbicide components, a relatively broad spectrum of annual and perennial broad-leaved weeds, weed grasses and Cyperaceae is controlled by the pre- and post-emergence method.

The application rates of the herbicide components in the herbicidal composition are in the weight ratios stated below:
(range component A):(range component B):(range component C)
generally (1-2000):(10-5000):(1-500),
preferably (3-40):(10-100):(1-30),
particularly preferably (1-10):(8-32):(1-8).

The application rates of the respective herbicide components in the herbicidal composition are:
component A: generally 10-2000 g of AS/ha, preferably 30-400 g of AS/ha, particularly preferably 50-300 g of AS/ha flufenacet;
component B: generally 50-3000 g of AS/ha, preferably 100-1000 g of AS/ha, particularly preferably 200-1500 g of AS/ha diclofop(-P-methyl);
component C: generally 1-500 g of AS/ha, preferably 10-300 g of AS/ha, particularly preferably 30-200 g of AS/ha diflufenican.

Correspondingly, the application rates mentioned above may be used to calculate the percentages by weight (% by weight) of the herbicide components based on the total weight of the herbicidal compositions, which may additionally also comprise other components.

When using the active compounds of the herbicidal compositions according to the invention in crop plants, it may be expedient, depending on the crop plant, to apply a safener above certain application rates to reduce or prevent any damage to the crop plant. Such safeners are known to the person skilled in the art. Suitable safeners are (S1-1) mefenpyr(-diethyl), (S1-7) fenchlorazole(-ethyl), (S1-12) isoxadifen(-ethyl), (S2-1) cloquintocet(-mexyl), (S3-1) dichlormid, (S3-2) R-29148 (3-dichloroacetyl-2,2,5-trimethyl-1,3-oxazolidine), (S3-3) R-28725 (3-dichloroacetyl-2,2-dimethyl-1,3-oxazolidine), (S3-4) benoxacor, (S3-5) PPG-1292 (N-allyl-N-[(1,3-dioxolan-2-yl)methyl]dichloroacetamide), (S3-6) DKA-24 (N-allyl-N-[(allylaminocarbonyl)methyl]dichloroacetamide), (S3-7) AD-67/MON 4660 (3-dichloroacetyl-1-oxa-3-azaspiro[4,5]decane), (S3-8) TI-35 (1-dichloroacetyl-azepane), (S3-9) dicyclonon, (S3-10)/(S3-11) furilazole, (S4-1) cyprosulfamide, (S7-1) methyl (diphenylmethoxy)acetate (CAS-Regno: 41858-19-9), (S9-1) 1,2-dihydro-4-hydroxy-1-methyl-3-(5-tetrazolylcarbonyl)-2-quinolone (CAS-Regno: 95855-00-8), (S11-1) oxabetrinil, (S11-2) fluxofenim, (S11-3) cyometrinil, (S12-1) methyl [(3-oxo-1H-2-benzothiopyran-4(3H)-ylidene)methoxy]acetate (CAS-Regno: 205121-04-6), (S13-1) naphthalic anhydride, (S13-2) fenclorim, (S13-3) flurazole, (S13-4) CL-304415 (4-carboxy-3,4-dihydro-2H-1-benzopyran-4-acetic acid), (S13-5) MG-191 (2-dichloromethyl-2-methyl-1,3-dioxolane), (S13-6) MG-838 (2-propenyl 1-oxa-4-azaspiro[4.5]decane-4-carbodithioate), (S13-7) disulfoton (O,O-diethyl S-2-ethylthioethyl phosphorodithioate), (S13-8) dietholate, (S13-9) mephenate; particularly preferably (S1-1) mefenpyr(-diethyl), (S1-7) fenchlorazole(-ethyl), (S1-12) isoxadifen(-ethyl), (S2-1) cloquintocet(-mexyl), (S3-1) dichlormid, (S3-4) benoxacor, (S3-7) AD-67/MON 4660 (3-dichloroacetyl-1-oxa-3-azaspiro[4,5]decane), (S3-8) TI-35 (1-dichloroacetylazepane), (S3-10)/(S3-11) furilazole, (S4-1) cyprosulfamide, (S11-1) oxabetrinil, (S11-2) fluxofenim, (S11-3) cyometrinil, (S13-1) naphthalic anhydride, (S13-2) fenclorim, (S13-3) flurazole; very particularly preferably (S1-1) mefenpyr(-diethyl), (S1-7) fenchlorazole(-ethyl), (S1-12) isoxadifen(-ethyl), (S2-1) cloquintocet(-mexyl), (S3-1) dichlormid, (S3-4) benoxacor, (S3-7) AD-67/MON 4660 (3-dichloroacetyl-1-oxa-3-azaspiro[4,5]decane), (S3-10)/(S3-11) furilazole, (S4-1) cyprosulfamide, (S11-2) fluxofenim, (S13-2) fenclorim, (S13-3) flurazole, (S14-1) daimuron (syn. SK 23, 1-(1-methyl-1-phenylethyl)-3-p-tolylurea).

Particularly preferred combinations of herbicidal compositions according to the invention and safeners are those in which the safener is selected from the group of safeners consisting of the compounds (S1-1) mefenpyr(-diethyl), (S1-12) isoxadifen(-ethyl), (S2-1) cloquintocet (-mexyl), (S4-1) cyprosulfamide, very particularly preferred as safener are (S1-1) mefenpyr(-diethyl), (S1-12) isoxadifen(-ethyl), and (S4-1) cyprosulfamide. Particularly preferred for application in rice are (S1-12) isoxadifen(-ethyl), (S13-2) fenclorim and (S14-1) daimuron. Particularly preferred for application in cereals are (S1-1) mefenpyr(-diethyl), (S2-1) cloquintocet (-mexyl), (S4-1) cyprosulfamide, in corn in particular (S1-12) isoxadifen(-ethyl), (S3-1) dichlormid, (S3-4) benoxacor and (S4-1) cyprosulfamide. Preferred for application in sugar cane are (S1-12) isoxadifen(-ethyl) and (S4-1) cyprosulfamide.

Depending on the indication and the amounts used of the herbicidal compositions according to the invention, the required application rates of the safeners may vary within wide limits and are generally in the range of from 1 to 5000 g, preferably from 5 to 2500 g, in particular from 10 to 1000 g, of active compound per hectare.

The weight ratio of the herbicidal compositions according to the invention: safeners may vary within wide limits and is preferably in the range of from 1:50 000 to 500:1, in particular from 1:8000 to 250:1, very particularly preferably from 1:2500 to 50:1. The particular optimum amounts of the herbicidal compositions according to the invention and safeners depend both on the type of safener used and on the species and the development stage of the crop stand to be treated, and they can be determined on a case-to-case basis by simple preliminary routine tests.

With respect to the application, the herbicidal composition according to the invention and safener can be applied jointly, for example as a coformulation or as a tank mix; however, they can also be applied as a split application over time. Another possibility is the application in a plurality of portions (sequential application), for example after applications as seed treatment or pre-sowing (plant) treatment or by the pre-emergence method, followed by post-emergence applications or early post-emergence applications, followed by applications at medium or late post-emergence. Preferred is the simultaneous or nearly simultaneous application of herbicidal composition according to the invention and safener, particularly preferably joint application.

The invention also embraces herbicide combinations which, in addition to the components A, B and C, also comprise one or more further agrochemically active compounds from the group of the insecticides and fungicides. The preferred conditions illustrated above apply to such combinations.

The herbicidal compositions according to the invention have excellent herbicidal activity against a broad spectrum of economically important monocotyledonous and dicotyledonous harmful plants, such as broad-leaved weeds, weed grasses or Cyperaceae, including species which are resistant to herbicidally active compounds such as, for example, glyphosate, glufosinate, atrazine, photosynthesis inhibitors, imidazolinone herbicides, sulfonylureas, (hetero)aryloxyaryloxyalkylcarboxylic acids or -phenoxyalkylcarboxylic acids (‘fops’), cyclohexanedione oximes (‘dims’) or auxin inhibitors. The active compounds also act efficiently on perennial weeds which produce shoots from rhizomes, root stocks and other perennial organs and which are difficult to control. Here, the substances can be applied, for example, by the pre-sowing method, the pre-emergence method or the post-emergence method, for example jointly or separately.

Specific examples may be mentioned of some representatives of the monocotyledonous and dicotyledonous weed flora which can be controlled by the herbicidal compositions according to the invention, without the enumeration being restricted to certain species.

Examples from amongst the monocotyledonous weed species are, Avena spp., Alopecurus spp., Apera spp., Brachiaria spp., Bromus spp., Digitaria spp., Lolium spp., Echinochloa spp., Leptochloa spp., Fimbristylis spp., Panicum spp., Phalaris spp., Poa spp., Setaria spp. and also Cyperus species from the annual group, and, among the perennial species, Agropyron, Cynodon, Imperata and Sorghum and also perennial Cyperus species.

In the case of the dicotyledonous weed species, the spectrum of action extends to genera such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. Eclipta spp., Sesbania spp., Aeschynomene spp. and Viola spp., Xanthium spp. among the annuals, and Convolvulus, Cirsium, Rumex and Artemisia in the case of the perennial weeds.

If the herbicidal compositions according to the invention are applied to the soil surface before germination, the weed seedlings are either prevented completely from emerging or else the weeds grow until they have reached the cotyledon stage, but then their growth stops, and, eventually, after two to four weeks have elapsed, they die completely.

If the herbicidal compositions according to the invention are applied post-emergence to the green parts of the plants, growth likewise stops drastically a very short time after the treatment, and the weed plants remain at the growth stage of the point of time of application, or they die completely after a certain time, so that in this manner competition by the weeds, which is harmful to the crop plants, is eliminated very early and in a sustained manner. In the case of rice, the herbicidal compositions according to the invention can also be applied into the water, and they are then taken up via soil, shoot and roots.

The herbicidal compositions according to the invention are distinguished by a rapidly commencing and long-lasting herbicidal action. In general, the rainfastness of the active compounds in the compositions according to the invention is favorable. A particular advantage is that the dosages used in the compositions according to the invention and the effective dosages of components A, B and C can be adjusted to such a low level that their soil action is optimally low. This does not only allow them to be employed in sensitive crops in the first place, but ground water contaminations are virtually avoided. The combination according to the invention of active compounds allows the required application rate of the active compounds to be reduced considerably.

When the components A, B and C are applied jointly in the compositions according to the invention, there are, in a preferred embodiment, as improvement of the application profile, superadditive (=synergistic) effects. Here, the activity in the combinations is higher than the expected sum of the activities of the individual herbicides employed. The synergistic effects allow a higher and/or longer-lasting efficacy (persistency); a broader spectrum of broad-leaved weeds, weed grasses and Cyperaceae to be controlled, in some cases with only one or only a few applications; a more rapid onset of the herbicidal action the control of hitherto uncontrollable species (gaps); control, for example, of species which are tolerant or resistant to individual herbicides or a plurality of herbicides; an extended application period and/or a reduced number of individual applications required or a reduction of the overall application rate and—as a result for the user—more advantageous weed control systems both from an economical and ecological point of view.

The abovementioned properties and advantages are necessary for weed control practice to keep agricultural/forestry/horticultural crops or green land/meadows or crops for energy generation (biogas, bioethanol) free of unwanted competing plants, and thus to ensure and/or increase yield levels from the qualitative and quantitative angle. These novel combinations in the herbicidal compositions according to the invention markedly exceed the technical state of the art with a view to the properties described.

While the herbicidal compositions according to the invention have an outstanding herbicidal activity against monocotyledonous and dicotyledonous harmful plants, the crop plants are damaged only to a minor extent, if at all.

Some of the compositions according to the invention can additionally have growth-regulatory properties in crop plants. They engage in a plant's metabolism in a regulatory fashion and can thus be employed for targeted influencing of plant constituents and for facilitating harvesting, such as, for example, by triggering desiccation and stunted growth. Moreover, they are also suitable for generally controlling and inhibiting unwanted vegetative growth without destroying the plants in the process. Inhibiting the vegetative growth plays an important role in many monocotyledonous and dicotyledonous crops, allowing harvest losses as a result of lodging to be reduced or prevented completely.

By virtue of their improved application profile, the compositions according to the invention can also be employed for controlling harmful plants in crops of known plants or tolerant or genetically modified crop plants and energy plants which are yet to be developed. In general, the transgenic plants (GMOs) are distinguished by particularly advantageous properties, for example by resistances to certain pesticides, especially certain herbicides (such as, for example, resistances to components A, B and C in the compositions according to the invention), for example by resistances to harmful insects, plant diseases or plant pathogens, such as certain microorganisms such as fungi, bacteria or viruses. Other particular properties relate, for example, to the harvested material with respect to quantity, quality, storability, and also the composition of specific constituents. Thus, transgenic plants with an increased starch content or in which the quality of the starch is altered, or those having a different fatty acid composition of the harvested material or an enhanced vitamin content or energetic properties, are known. Further particular properties can be found in a tolerance or resistance to abiotic stress factors, for example heat, cold, drought, salt and ultraviolet radiation. By virtue of their herbicidal and other properties, the compositions according to the invention can likewise also be used for controlling harmful plants in crops of plants which are known or still to be developed plants obtained by mutant selection, and also of crossbreeds of mutagenic and transgenic plants.

Conventional ways of producing novel plants which have modified properties compared to existing plants consist, for example, in classic cultivation methods and the generation of mutants. Alternatively, novel plants with modified properties can be produced using genetic engineering methods (see, for example, EP 0221044 A, EP 0131624 A). For example, in several cases the following have been described: genetic modifications of crop plants for the purpose of modifying the starch synthesized in the plants (for example WO 92/011376 A, WO 92/014827 A, WO 91/019806 A); transgenic crop plants which are resistant to certain herbicides of the glufosinate type (cf., for example, EP 0242236 A, EP 0242246 A) or glyphosate (WO 92/000377 A) or of the sulfonylurea type (EP 0257993 A, U.S. Pat. No. 5,013,659) or to combinations or mixtures of these herbicides through “gene stacking”, such as transgenic crop plants e.g. corn or soybean with the tradename or the name Optimum™ GAT™ (glyphosate ALS tolerant); transgenic crop plants, for example cotton, with the capability of producing Bacillus thuringiensis toxins (Bt toxins) which make the plants resistant to certain pests (EP 0142924 A, EP 0193259 A); transgenic crop plants having a modified fatty acid composition (WO 91/013972 A); genetically modified crop plants having novel constituents or secondary compounds, for example novel phytoalexins providing increased resistance to disease (EP 0309862 A, EP 0464461 A); genetically modified plants having reduced photorespiration, which provide higher yields and have higher stress tolerance (EP 0305398 A); transgenic crop plants producing pharmaceutically or diagnostically important proteins (“molecular pharming”); transgenic crop plants distinguished by higher yields or better quality; transgenic crop plants distinguished by a combination, for example of the novel properties mentioned above (“gene stacking”).

A large number of molecular-biological techniques with which novel transgenic plants with modified properties can be generated are known in principle; see, for example, I. Potrykus and G. Spangenberg (eds.) Gene Transfer to Plants, Springer Lab Manual (1995), Springer Verlag Berlin, Heidelberg; or Christou, “Trends in Plant Science” 1 (1996) 423-431). To carry out such recombinant manipulations, nucleic acid molecules can be introduced into plasmids which permit a mutagenesis or a sequence modification by recombination of DNA sequences. For example, it is possible with the aid of standard methods to carry out base exchanges, to remove subsequences or to add natural or synthetic sequences. Adapters or linkers may be added in order to link the DNA fragments to each other, see, for example, Sambrook et al., 1989, Molecular Cloning, A Laboratory Manual, 2nd Ed. Cold Spring Harbor Laboratory Press, Cold Spring Harbor, N.Y.; or Winnacker “Gene and Klone” [Genes and Clones], VCH Weinheim 2nd Edition 1996.

For example, the generation of plant cells with a reduced activity of a gene product can be achieved by expressing at least one corresponding antisense RNA, a sense RNA for achieving a cosuppression effect or by expressing at least one suitably constructed ribozyme which specifically cleaves transcripts of the abovementioned gene product.

To this end, it is possible to use DNA molecules which encompass the entire coding sequence of a gene product inclusive of any flanking sequences which may be present, and also DNA molecules which only encompass portions of the coding sequence, it being necessary for these portions to be long enough to have an antisense effect in the cells. The use of DNA sequences which have a high degree of homology to the coding sequences of a gene product, but are not completely identical to them, is also possible.

When expressing nucleic acid molecules in plants, the protein synthesized can be localized in any desired compartment of the plant cell. However, to achieve localization in a particular compartment, it is possible, for example, to link the coding region with DNA sequences which ensure localization in a particular compartment. Such sequences are known to those skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106). Expression of the nucleic acid molecules may also take place in the organelles of the plant cells.

The transgenic plant cells can be regenerated by known techniques to give rise to entire plants. In principle, the transgenic plants can be plants of any desired plant species, i.e. not only monocotyledonous, but also dicotyledonous, plants. Thus, transgenic plants can be obtained whose properties are altered by overexpression, suppression or inhibition of homologous (=natural) genes or gene sequences or the expression of heterologous (=foreign) genes or gene sequences.

The present invention furthermore also provides a method for the control of unwanted vegetation, i.e., unwanted plants, (for example harmful plants), preferably in crop plants such as cereals (for example durum wheat and common wheat, barley, rye, oats, crossbreeds thereof such as triticale, planted or sown rice under ‘upland’ or ‘paddy’ conditions, corn, millet such as, for example, sorghum, sugar beet, sugar cane, oilseed rape, cotton, sunflowers, soybeans, potatoes, tomatoes, beans such as, for example, bush beans and broad beans, flax, pasture grass, fruit plantations, plantation crops, greens/lawns, and also squares of residential areas or industrial sites, rail tracks, particularly preferably in monocotyledonous crops such as cereals, for example wheat, barley, rye, oats, crossbreeds thereof such as triticale, rice, corn and millet and also dicotyledonous crops such as sunflowers, soybeans, potatoes, tomatoes, where the components A, B and C of the herbicidal compositions according to the invention are applied to the plants, for example harmful plants, plant parts, plant seeds or the area on which the plants grow, for example the area under cultivation jointly or separately, for example by the pre-emergence method (very early to late), post-emergence method or pre-emergence and post-emergence.

The invention also provides the method with the herbicidal compositions according to the invention comprising the components A, B and C for the selective control of harmful plants in crop plants, preferably in the crop plants mentioned above, and its use.

The invention also provides the method for controlling unwanted vegetation with the herbicidal compositions according to the invention comprising the components A, B and C, and its use in crop plants which have been modified by genetic engineering (transgenic) or by mutation selection, and which are resistant to growth regulators such as, for example, 2,4 D, dicamba, or against herbicides which inhibit essential plant enzymes, for example acetolactate synthases (ALS), EPSP synthases, glutamine synthases (GS) or hydroxyphenylpyruvate dioxygenases (HPPD), or to herbicides from the group of the sulfonylureas, glyphosates, glufosinates or benzoylisoxazoles and analogous active compounds or to any combinations of these active compounds. Particularly preferably, the herbicidal compositions according to the invention can be used in transgenic crop plants which are resistant to a combination of glyphosates and glufosinates, glyphosates and sulfonylureas or imidazolinones. Very particularly preferably, the herbicidal compositions according to the invention can be used in transgenic crop plants such as e.g. corn or soybean with the tradename or the name Optimum™ GAT™ (glyphosate ALS tolerant).

The invention also provides the use of the herbicidal compositions according to the invention comprising the components A, B and C for controlling harmful plants, preferably in crop plants, preferably in the crop plants mentioned above.

The herbicidal compositions according to the invention can also be used non-selectively for controlling unwanted vegetation, for example in plantation crops, at the wayside, on squares, industrial sites or railway installations; or selectively for controlling unwanted vegetation in crops for energy generation (biogas, bioethanol).

The herbicidal compositions according to the invention can be present either as mixed formulations of the components A, B and C and, if appropriate with further agrochemically active compounds, additives and/or customary formulation auxiliaries, which are then applied in a customary manner diluted with water, or prepared as tank mixes by joint dilution of the separately formulated or partially separately formulated components with water. In certain cases, the mixed formulations can be diluted with other liquids or solids, or else be applied in undiluted form.

The components A, B and C or their subcombinations can be formulated in various ways, depending on the prevailing biological and/or chemico-physical parameters. Examples of general formulations which are possible are: wettable powders (WP), water-soluble concentrates, emulsifiable concentrates (EC), aqueous solutions (SL), emulsions (EW), such as oil-in-water and water-in-oil emulsions, sprayable solutions or emulsions, suspension concentrates (SC), dispersions, oil dispersions (OD), suspoemulsions (SE), dusts (DP), seed-dressing products, granules for spreading or soil application (GR) or water-dispersible granules (WG), ultra-low volume formulations, microcapsule dispersions or wax dispersions.

The individual formulation types are known in principle and are described, for example, in: “Manual on Development and Use of FAO and WHO Specifications for Pesticides”, FAO and WHO, Rome, Italy, 2002; Winnacker-Küchler, “Chemische Technologie” [Chemical Engineering], Volume 7, C. Hanser Verlag Munich, 4th Ed. 1986; van Valkenburg, “Pesticide Formulations”, Marcel Dekker, N.Y., 1973; K. Martens, “Spray Drying” Handbook, 3rd Ed. 1979, G. Goodwin Ltd. London.

The formulation auxiliaries required, such as inert materials, surfactants, solvents and further additives, are likewise known and are described, for example, in: Watkins, “Handbook of Insecticide Dust Diluents and Carriers”, 2nd Ed., Darland Books, Caldwell N.J.; H. v. Olphen, “Introduction to Clay Colloid Chemistry”; 2nd Ed., J. Wiley & Sons, N.Y. Marsden, “Solvents Guide”, 2nd Ed., Interscience, N.Y. 1950; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzflächenaktive Äthylenoxidaddukte” [Surface-active ethylene oxide adducts], Wiss. Verlagsgesellschafts, Stuttgart 1976, Winnacker-Küchler, “Chemische Technologie”, Volume 7, C. Hanser Verlag Munich, 4th Ed. 1986.

Based on these formulations, it is also possible to prepare combinations with other agrochemically active compounds such as fungicides, insecticides and also safeners, fertilizers and/or growth regulators, for example in the form of a readymix or as tank mix.

Wettable powders (sprayable powders) are products which are uniformly dispersible in water and which, besides the active compounds and in addition to one or more diluents or inert substances, also comprise ionic and/or nonionic surfactants (wetting agents, dispersants), for example polyoxyethylated alkylphenols, polyethoxylated fatty alcohols or fatty amines, propylene oxide/ethylene oxide copolymers, alkanesulfonates or alkylbenzenesulfonates or alkylnaphthalenesulfonates, sodium lignosulfonate, sodium 2,2′-dinaphthylmethane-6,6′-disulfonate, sodium dibutylnaphthalenesulfonate or else sodium oleoylmethyltauride.

Emulsifiable concentrates are prepared by dissolving the active compounds in an organic solvent or solvent mixture, for example butanol, cyclohexanone, dimethylformamide, acetophenone, xylene or else higher-boiling aromatics or hydrocarbons with addition of one or more ionic and/or nonionic surfactants (emulsifiers). Examples of emulsifiers which may be used are: calcium salts of alkylarylsulfonic acids, such as calcium dodecylbenzenesulfonate, or nonionic emulsifiers such as fatty acid polyglycol esters, alkylaryl polyglycol ethers, fatty alcohol polyglycol ethers, propylene oxide/ethylene oxide copolymers, alkyl polyethers, sorbitan fatty acid esters, polyoxyethylene sorbitan fatty acid esters or polyoxyethylene sorbitol esters.

Dusts are obtained by grinding the active compound with finely divided solid materials, for example talc, natural clays such as kaolin, bentonite and pyrophyllite, or diatomaceous earth.

Suspension concentrates are water-based suspensions of active compounds. They can be prepared, for example, by wet grinding by means of commercially available bead mills and, if appropriate, addition of further surfactants as they have already been mentioned for example above in the case of the other formulation types. In addition to the suspended active compound or active compounds, other active compounds may also be present in the formulation in dissolved form.

Oil dispersions are oil-based suspensions of active compounds, where oil is to be understood as meaning any organic liquid, for example vegetable oils, aromatic or aliphatic solvents, or fatty acid alkyl esters. They can be prepared, for example, by wet grinding by means of commercially available bead mills and, if appropriate, addition of further surfactants (wetting agents, dispersants) as they have already been mentioned for example above in the case of the other formulation types. In addition to the suspended active compound or active compounds, other active compounds may also be present in the formulation in dissolved form.

Emulsions, for example oil-in-water emulsions (EW), can be prepared for example by means of stirrers, colloid mills and/or static mixers from mixtures of water and water-immiscible organic solvents and, if appropriate, further surfactants as have already been mentioned for example above in the case of the other formulation types. Here, the active compounds are present in dissolved form.

Granules can be prepared either by spraying the active compound onto adsorptive, granulated inert material or by applying active compound concentrates to the surface of carriers such as sand, kaolinites, chalk or granulated inert material with the aid of binders, for example polyvinyl alcohol, sodium polyacrylate or else mineral oils. Suitable active compounds may also be granulated in the manner conventionally used for the production of fertilizer granules, if desired in a mixture with fertilizers. Water-dispersible granules are generally prepared by customary processes such as spray drying, fluidized-bed granulation, disk granulation, mixing with high-speed mixers and extrusion without solid inert material. Regarding the production of disk granules, fluidized-bed granules, extruder granules and spray granules, see, for example, methods in “Spray-Drying Handbook” 3rd ed. 1979, G. Goodwin Ltd., London; J. E. Browning, “Agglomeration”, Chemical and Engineering 1967, page 147 et seq; “Perry's Chemical Engineer's Handbook”, 5th Ed., McGraw-Hill, New York 1973, pp. 8-57.

More details on the formulation of crop protection compositions can be found, for example, in G. C. Klingman, “Weed Control as a Science”, John Wiley and Sons, Inc., New York, 1961, pages 81-96 and J. D. Freyer, S. A. Evans, “Weed Control Handbook”, 5th Ed Blackwell Scientific Publications, Oxford, 1968, pages 101-103.

The agrochemical formulations generally comprise from 0.1 to 99 percent by weight, in particular from 2 to 95% by weight, active compounds of the herbicide components, the following concentrations being customary depending on the type of formulation: In wettable powders, the active compound concentration is, for example, approximately 10 to 95% by weight, the remainder to 100% by weight being composed of customary formulation components. In the case of emulsifiable concentrates, the active compound concentration can, for example, amount to from 5 to 80% by weight. Formulations in the form of dusts generally comprise from 5 to 20% by weight of active compound, and sprayable solutions comprise approximately 0.2 to 25% by weight of active compound. In the case of granules such as dispersible granules, the active compound content depends partly on whether the active compound is in liquid or solid form and on the granulation auxiliaries and fillers which are being used. In the case of the water-dispersible granules, the content is generally between 10 and 90% by weight. In addition, the abovementioned active compound formulations may comprise, if appropriate, the respective customary adhesives, wetting agents, dispersants, emulsifiers, preservatives, antifreeze agents, solvents, fillers, colorants, carriers, antifoams, evaporation inhibitors, pH regulators or viscosity regulators.

The herbicidal activity of the herbicide combinations according to the invention can be improved, for example, by surfactants, for example by wetting agents from the group of the fatty alcohol polyglycol ethers. The fatty alcohol polyglycol ethers preferably contain 10-18 carbon atoms in the fatty alcohol radical and 2-20 ethylene oxide units in the polyglycol ether moiety. The fatty alcohol polyglycol ethers can be present as sodium and potassium salts or ammonium salts, or else as alkaline earth metal salts such as magnesium salts, such as sodium C₁₂/C₁₄-fatty alcohol diglycol ether sulfate (Genapol® LRO, Clariant GmbH); see, for example, EP-A-0476555, EP-A-0048436, EP-A-0336151 or U.S. Pat. No. 4,400,196 and also Proc. EWRS Symp. “Factors Affecting Herbicidal Activity and Selectivity”, 227-232 (1988). Nonionic fatty alcohol polyglycol ethers are, for example, (C₁₀-C₁₈)—, preferably (C₁₀-C₁₄)-fatty alcohol polyglycol ethers (for example isotridecyl alcohol polyglycol ethers) which comprise, for example, 2-20, preferably 3-15, ethylene oxide units, for example from the Genapol® X series, such as Genapol® X-030, Genapol® X-060, Genapol® X-080 or Genapol® X-150 (all from Clariant GmbH).

The present invention furthermore comprises the combination of the components A, B and C with the wetting agents mentioned above from the group of the fatty alcohol polyglycol ethers having preferably 10-18 carbon atoms in the fatty alcohol radical and 2-20 ethylene oxide units in the polyglycol ether moiety and which may be present in nonionic or ionic form (for example as fatty alcohol polyglycol ether sulfates). Preference is given to sodium C₁₂/C₁₄-fatty alcohol diglycol ether sulfate (Genapol® LRO, Clariant GmbH) and isotridecyl alcohol polyglycol ethers having 3-15 ethylene oxide units, for example from the Genapol® X series, such as Genapol® X-030, Genapol® X-060, Genapol® X-080 and Genapol® X-150 (all from Clariant GmbH). Furthermore, it is known that fatty alcohol polyglycol ethers such as nonionic or ionic fatty alcohol polyglycol ethers (for example fatty alcohol polyglycol ether sulfates) are also suitable as penetrants and activity enhancers for a number of other herbicides, inter alia also for herbicides from the group of the imidazolinones (see, for example, EP-A-0502014).

The herbicidal action of the herbicide combinations according to the invention can also be increased by using vegetable oils. The term “vegetable oils” is to be understood as meaning oils of oleaginous plant species, such as soybean oil, rapeseed oil, corn oil, sunflower oil, cottonseed oil, linseed oil, coconut oil, palm oil, thistle oil or castor oil, in particular rapeseed oil, and also their transesterification products, for example alkyl esters, such as rapeseed oil methyl ester or rapeseed oil ethyl ester.

The vegetable oils are preferably esters of C₁₀-C₂₂—, preferably C₁₂-C₂₀—, fatty acids. The C₁₀-C₂₂-fatty acid esters are, for example, esters of unsaturated or saturated C₁₀-C₂₂-fatty acids having, in particular, an even number of carbon atoms, for example erucic acid, lauric acid, palmitic acid and in particular C₁₈-fatty acids such as stearic acid, oleic acid, linoleic acid or linolenic acid.

Examples of C₁₀-C₂₂-fatty acid esters are esters which are obtained by reacting glycerol or glycol with the C₁₀-C₂₂-fatty acids present, for example, in oils of oleaginous plant species, or C₁-C₂₀-alkyl C₁₀-C₂₂-fatty acid esters which can be obtained, for example, by transesterification of the glycerol or glycol C₁₀-C₂₂-fatty acid esters mentioned above with C₁-C₂₀-alcohols (for example methanol, ethanol, propanol or butanol). The transesterification can be carried out by known methods as described, for example, in Römpp Chemie Lexikon, 9^{th} edition, volume 2, page 1343, Thieme Verlag Stuttgart.

Preferred C₁-C₂₀-alkyl C₁₀-C₂₂-fatty acid ester are methyl esters, ethyl esters, propyl esters, butyl esters, 2-ethylhexyl esters and dodecyl esters. Preferred glycol and glycerol C₁₀-C₂₂-fatty acid esters are the uniform or mixed glycol esters and glycerol esters of C₁₀-C₂₂-fatty acids, in particular fatty acids having an even number of carbon atoms, for example erucic acid, lauric acid, palmitic acid and in particular C₁₈-fatty acids such as stearic acid, oleic acid, linoleic acid or linolenic acid.

The vegetable oils can be present in the herbicidal compositions according to the invention for example in the form of commercially available oil-containing formulation additives, in particular those based on rapeseed oil, such as Hasten® (Victorian Chemical Company, Australia, hereinbelow referred to as Hasten, main ingredient: rapeseed oil ethyl ester), Actirob® B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

In a further embodiment, the present invention embraces combinations of the components A, B and C with the vegetable oils mentioned above, such as rapeseed oil, preferably in the form of commercially available oil-containing formulation additives, in particular those based on rapeseed oil, such as Hasten®, Actirob® B, Rako-Binol®, Renol® or Stefes Mero®.

For use, the formulations, which are present in commercially available form, are optionally diluted in the customary manner, for example in the case of wettable powders, emulsifiable concentrates, dispersions and water-dispersible granules with water. Preparations in the form of dusts, soil granules, granules for broadcasting and sprayable formulations are usually not diluted further with other inert substances prior to use.

The active compounds can be applied to the plants, parts of the plants, seeds of the plants or the area on which the plants grow (the soil of the field), preferably to the green plants and parts of the plants and, if appropriate, additionally to the soil.

One possible use is the joint application of the active compounds in the form of tank mixes, the concentrated formulations of the individual active compounds, in optimal formulations, jointly being mixed with water in the tank and the resulting spray liquor being applied.

A joint herbicidal formulation of the herbicidal compositions according to the invention comprising the components A, B and C has the advantage of being easier to apply since the quantities of the components are already presented in the correct ratio to each other. Moreover, the auxiliaries in the formulation can be matched optimally to each other.

### A. General Formulation Examples

a) A dust is obtained by mixing 10 parts by weight of an active compound /active compound mixture and 90 parts by weight of talc as inert material and comminuting the mixture in a hammer mill.
b) A wettable powder which is readily dispersible in water is obtained by mixing 25 parts by weight of an active compound/active compound mixture, 64 parts by weight of kaolin-containing quartz as inert material, 10 parts by weight of potassium lignosulfonate and 1 part by weight of sodium oleoylmethyltaurinate as wetting agent and dispersant, and grinding the mixture in a pinned-disk mill.
c) A suspension concentrate which is readily dispersible in water is obtained by mixing 20 parts by weight of an active compound/active compound mixture with 5 parts by weight of tristyrylphenol polyglycol ether (Soprophor BSU), 1 part by weight of sodium lignosulfonate (Vanisperse CB) and 74 parts by weight of water, and grinding the mixture in a ball mill to a fineness of below 5 microns.
d) An oil dispersion which is readily dispersible in water is obtained by mixing 20 parts by weight of an active compound/active compound mixture with 6 parts by weight of alkylphenol polyglycol ether (Triton® X 207), 3 parts by weight of isotridecanol polyglycol ether (8 ED) and 71 parts by weight of paraffinic mineral oil (boiling range for example approx. 255 to 277° C.), and grinding the mixture in a ball mill to a fineness of below 5 microns.
e) An emulsifiable concentrate is obtained from 15 parts by weight of an active compound/active compound mixture, 75 parts by weight of cyclohexanone as solvent and 10 parts by weight of oxyethylated nonylphenol as emulsifier.
f) Water-dispersible granules are obtained by mixing
   75 parts by weight of an active compound/active compound mixture,
   10 parts by weight of calcium lignosulfonate,
   5 parts by weight of sodium lauryl sulfate,
   3 parts by weight of polyvinyl alcohol and
   7 parts by weight of kaolin,
   grinding the mixture on a pinned-disk mill and granulating the powder in a fluidized bed by spraying on water as granulation liquid.
g) Water-dispersible granules are also obtained by homogenizing and precomminuting, in a colloid mill,
   25 parts by weight of an active compound/active compound mixture,
   5 parts by weight of sodium 2,2′-dinaphthylmethane-6,6′-disulfonate,
   2 parts by weight of sodium oleoylmethyltaurinate,
   1 part by weight of polyvinyl alcohol,
   17 parts by weight of calcium carbonate and
   50 parts by weight of water,
   subsequently grinding the mixture in a bead mill and atomizing and drying the resulting suspension in a spray tower by means of a single-substance nozzle.

### B. Biological Examples

### a) Description of the Methods

### Greenhouse Trials

In the standard design of the test, seeds of various broad-leaved weed and weed grass biotypes (origins) were sown in a 8-13 cm diameter pot filled with natural soil of a standard field soil (loamy silt; non-sterile) and covered with a covering soil layer of about 1 cm. The pots were then cultivated in a greenhouse (12-16 h of light, temperature day 20-22° C., night 15-18° C.) until the time of application. The pots were treated on a laboratory track sprayer with spray liquors comprising the compositions according to the invention, mixtures of the prior art or components used individually. Application of the active compounds or active compound combinations formulated as WG, WP, EC or otherwise was carried out at the appropriate growth stages of the plants. The application rate for the spray application was 100-600 l of water/ha. After the treatment, the plants were returned to the greenhouses.

About 3 weeks after the application, the soil action or/and foliar action was assessed visually according to a scale of 0-100% in comparison to an untreated comparative group: 0%=no noticeable effect compared to the untreated comparative group; 100%=full effect compared to the untreated comparative group.

(notes: the term “seeds” also includes vegetative propagation forms such as, for example, rhizome pieces; abbreviations used: h light=hours of illumination, g of AS/ha=gram of active substance per hectare, l/ha=liter per hectare, S=sensitive, R=resistant)
1. Post-emergence action against weeds: seeds of various broad-leaved weed and weed grass biotypes (origins) were sown in a 8-13 cm diameter pot filled with natural soil of a standard field soil (loamy silt; non-sterile) and covered with a covering soil layer of about 1 cm. The pots were then cultivated in a greenhouse (12-16 h of light, temperature day 20-22° C., night 15-18° C.) until the time of application. The pots were treated at various BBCH stages between 11-25 of the seeds/plants, i.e. generally between two to three weeks after the start of the cultivation, on a laboratory track sprayer with spray liquors comprising the compositions according to the invention, mixtures or components used individually, as WG, WP, EC or other formulations. The application rate for the spray application was 100-600 l of water/ha. After the treatment, the plants were returned to the greenhouses and, when required, treated with fertilizer and watered.
2. Selective post-emergence action: seeds of various crop species (origins) were sown in a 8-13 cm diameter pot filled with natural soil of a standard field soil (loamy silt; non-sterile) and covered with a covering soil layer of about 1 cm. The pots were then cultivated in a greenhouse (12-16 h of light, temperature day 20-22° C., night 15-18° C.) until the time of application. The pots were treated at various BBCH stages between 11-32 of the seeds/plants, i.e. generally between two to four weeks after the start of the cultivation, on a laboratory track sprayer with spray liquors comprising the compositions according to the invention, mixtures or components used individually, as WG, WP, EC or other formulations. The application rate for the spray application was 100-600 l of water/ha. After the treatment, the plants were returned to the greenhouses and, when required, treated with fertilizer and watered. The pots were cultivated in a greenhouse (12-16 h light, temperature day 20-22° C., night 15-18° C.).

### b) Results

The following abbreviations were used:

BBCH=BBCH code provides information about the morphological development stage of a plant. Officially, the abbreviation denotes the Biologische Bundesanstalt, Bundessortenamt and CHemische Industrie [Federal Biological Institute for Agriculture and Forestry, Federal Office for Crop Plant Varieties, Chemical Industry]. The range of BBCH 00-10 denotes the germination stages of the seeds until surface penetration. The range of BBCH 11-25 denotes the leaf development stages until stocking (corresponds to the number of tillers or side-shoots).

PE=pre-emergence soil application; BBCH of the seeds/plants 00-10

PO=post-emergence application on the green parts of the plants; BBCH of the plants 11-25

incorporation=the appropriate amount of spray liquor per area was incorporated manually into the soil of the covering layer.

ED73 soil=standard soil consisting of subsoil clay and high-quality peat

IU soil=loamy silt—standard field soil

TSR=target-site resistance. The weed populations comprise biotypes having a site-of-action-specific resistance, i.e. the binding site at the site of action is modified as a result of natural mutations in the gene sequence so that the active compounds are no longer able to bind, or bind in an unsatisfactory manner, and are therefore no longer able to act.

EMR=enhanced metabolic resistance. The weed populations comprise biotypes having a metabolic resistance, i.e. the plants are capable to metabolize the active compounds more quickly via enzyme complexes, i.e. the active compounds are degraded more rapidly in the plant.

HRAC=Herbicide Resistance Action Committee. Committee of the research-conducting industries, which classifies the approved active compounds according to their mode of action (e.g. HRAC group B=acetolactate synthase inhibitors (ALS)).

HRAC group A=acetylcoenzyme-A carboxylase inhibitors (ACCase)-diclofop.

HRAC group B=acetolactate synthase inhibitors (ALS)).

HRAC group F1=phytoendesaturase (PDS)—diflufenican

HRAC group K3=inhibitors of cell division—flufenacet.

Dose g of AS/ha=application rate in gram of active substance per hectare.

AS=active substance (based on 100% of active ingredient)=a.i.

STEME=Stellaria media=weed

APESV=Apera Spica-venti=weed

ALOMY=Alopecurus myosuroides=weed

TRZAW=Triticum aestivum, winter wheat=crop plant

TRZAS=Triticum aestivum, summer wheat=crop plant

The activities of the herbicidal compositions according to the invention meet the requirements and therefore solve the object of improving the application profile of the herbicidally active compound flufenacet (inter alia provision of more flexible solutions with regard to the application rates required for unchanged to enhanced activity).

Insofar as herbicidal effects of the compositions according to the invention compared to mixtures of the prior art or compared to components applied individually against economically important mono- and dicotyledonous harmful plants were the center of attention, the synergistic herbicidal activities were calculated using Colby's formula (cf. S. R. Colby; Weeds 15 (1967), 20-22):

E=(A+B+C)−(A×B+A×C+B×C)/100+(A×B×C)/10 000
in which:
A, B, C=each the activity of the components A or B or C in percent at a dosage of a or b gram of AS/ha;
E^{C}=expected value according to Colby in % at a dosage of a+b gram of AS/ha.
Δ=difference (%) of measured value−%-to expected value−%-(measured value minus expected value)
Δ^{D}=difference (%) of the measured value of an observation A−%-to the measured value of an observation B−%. Depending on the design of the test, the observed values A and B may vary and are defined in the results section (for example ratio: A=PE soil application, to B=incorporation into the soil; or A=PE soil application, to B=pre-sowing soil application etc.).
Evaluation:
   -measured values: in each case for (A), (B) and (A)+(B) in
Assessment:
   -measured value (%) greater >than E^{C}: synergism (+Δ)
   -measured value (%) equal to =E^{C}: [symbol] additive action (±0Δ)
   -measured value (%) smaller <than E^{C}: [symbol] antagonism (−Δ)

Here, the herbicidal activities of the compositions according to the invention exceeded the expected values which had been calculated using Colby's formula.

### Greenhouse Trials

As standard, unless mentioned otherwise, the application of flufenacet took place as a SC 500 formulation, corresponding to 500 g of active substance per liter of formulated product. The application of diflufenican took place as a SC 500 formulation, corresponding to 500 g of active substance per liter of formulated product. The application of diclofop-methyl took place as an EC 284 formulation, corresponding to 284 g of active substance per kilogram of formulated product.

TABLE 1
Comparison of the activity of the mixtures on PO
application according to test methods 1 and 2.

| PO | Dosage | | | |
|---|---|---|---|---|
| application | g of AS/ha | ALOMY | STEME | APESV |
| (A) flufenacet | 120 | 65 | 30 | 60 |
| (B) diclofop | 378 | 15 | 0 | 0 |
| (C) diflufenican | 120 | 10 | 30 | 5 |
| (A) + (B) + (C) | 120 + | 97 | 98 | 85 |
| | 378 + 120 | E^{c} = 73; Δ + 24 | E^{c} = 51; Δ + 47 | E^{c} = 62; Δ + 23 |

| PO | Dosage | | |
|---|---|---|---|
| application | g of AS/ha | TRZAW | TRZAS |
| (A) flufenacet | 120 | 50 | 40 |
| (B) diclofop | 378 | 20 | 10 |
| (C) diflufenican | 120 | 5 | 5 |
| (A) + (B) + (C) | 120 + | 30 | 20 |
| | 378 + 120 | E^{c} = 62; Δ − 32 | E^{c} = 49; Δ − 29 |

Compared to the activity of the individual active compounds, the mixture achieved a high synergistic activity for the plant species examined (Δ+23−+47).At the same time, following PO application the crop compatibility was markedly improved (Δ−29−−32; negative values for crop plants mean improved crop plant compatibility). In the mixture, the application flexibility of the active compounds is broadened. The individual active compounds flufenacet and diflufenican are primarily applied only PE, the mixture therefore allowing an application at later growth stages.

Comment: On PO application, reliability of action is increased and crop plant compatibility is improved.

1. A herbicidal composition comprising, as the only herbicidally active components,
A) flufenacet (component A),
B) diclofop(-P-methyl) (component B) and
C) diflufenican (component C).

2. The herbicidal composition as claimed in claim 1 wherein said components are in a weight ratio
(range component A):(range component B):(range component C) of (1-2000):(10-5000):(1-500).

3. The composition according claim 2 wherein the weight ratio of (range component A):(range component B):(range component C) is (3-40):(10-100):(1-30).

4. The composition according to claim 2 wherein the weight ratio of (range component A):(range component B):(range component C) is (1-10):(8-32):(1-8).

5. The herbicidal composition as claimed in claim 1 further comprising agriculturally acceptable formulation auxiliaries and/or additives.

6. The herbicidal composition as claimed in claim 1 further comprising formulation auxiliaries and/or additives customary in crop protection.

7. The herbicidal composition as claimed in claim 1, further comprising one or more agrochemically active compounds.

8. The herbicidal composition according to claim 7 wherein the one or more agrochemically active compounds is selected from the group consisting of insecticides and fungicides.

9. The herbicidal composition as claimed in claim 1, further comprising a safener.

10. A method of controlling unwanted plants comprising applying the composition according to claim 1 to said unwanted plants.

11. The method according to claim 10 wherein component A is applied from 10-2000 g of AS/ha.

12. The method according to claim 11 wherein component A is applied at a rate of from 30-400 g of AS/ha.

13. The method according to claim 12 wherein component A is applied at a rate of from 50-300 g of AS/ha.

14. The method according to claim 10 wherein component B is applied at a rate of from 50-3000 g of AS/ha.

15. The method according to claim 14 wherein component B is applied at a rate of from 200-1500 g of AS/ha.

16. The method according to claim 15 wherein component B is applied at a rate of from 100-1000 g of AS/ha.

17. The method according to claim 10 wherein component C is applied at a rate of from 1-500 g of AS/ha.

18. The method according to claim 17 wherein component C is applied at a rate of from 10-300 g of AS/ha.

19. The method according to claim 18 wherein component C is applied at a rate of from 30-200 g of AS/ha.

20. The method according to claim 10 wherein the components A, B and C are applied jointly or separately to the unwanted plants, plant parts of the unwanted plants, plant seeds of the unwanted plants or to the area on which or from which the unwanted plants grow.

21. The method according to claim 10 wherein the unwanted plants are harmful plants.

22. The method according to claim 10 wherein the composition is applied to crop plants.

23. The method according to claim 22 wherein the crop plants are genetically modified or have been obtained by mutation selection.
